(19) United States
(12) Patent Application Publication
(10) Pub. No.: US 2026/0079696 A1
(43) Pub. Date: Mar. 19, 2026

(54) ANALYSIS AND CLASSIFICATION METHODS AND SYSTEMS FOR ASSESSING, IDENTIFYING, AND TRACKING TECHNICAL DEBT IN ORGANIZATIONS

(71) Applicant: TEACHERS INSURANCE AND ANNUITY ASSOCIATION OF AMERICA, New York, NY (US)

(72) Inventors: Sonam Jha, Skillman, NJ (US); Rares Ioan Almasan, Paradise Valley, AZ (US); Sriram Venkatesan, Princeton Junction, NJ (US); Sastry VSM Durvasula, Phoenix, AZ (US); Swatee Singh, Livingston, NJ (US); Thomas Matthew Verutes, Rockville Centre, NY (US); Geeta Pyne, San Jose, CA (US)

(21) Appl. No.: 18/889,583

(22) Filed: Sep. 19, 2024

(51) Int. Cl. G06F 8/71; G06F 8/77

(52) U.S. Cl. CPC G06F 8/71; G06F 8/77

(57) ABSTRACT

A computing system assesses, identifies, and tracks technical debt by analyzing code repositories, application architecture diagrams, and process flows, classifying the debt into application and enterprise debt. A method involves analyzing code repositories, classifying technical debt, and utilizing an AI model. A computer-readable medium includes instructions for assessing and classifying technical debt.

### FIELD OF THE INVENTION

The present aspects relate to computing systems and methods for managing technical debt within organizations, and more particularly, to systems and methods that utilize artificial intelligence to assess, identify, and track technical debt by analyzing various data sources such as code repositories, application architecture diagrams, and process flows, such as employing generative AI models for technical debt identification.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Organizations across industries grapple with the challenge of managing technical debt, a predicament stemming from the necessity to quickly adapt technologies, which leads to compromises in software design, code quality, and overall architecture. The rapid pace of technological advancements necessitates continuous adaptation and evolution of software systems to meet changing business requirements. However, this often results in the accumulation of technical debt, characterized by outdated code, suboptimal designs, and technology that no longer aligns with current standards or business needs. This accumulation not only hinders the ability to introduce new features efficiently but also increases the maintenance cost and complexity of the software over time. More problematically, technical debt is often concentrated around mission critical computing systems, where any changes or maintenance operations present the highest levels of risk.

Further, the conventional methods of assessing and managing technical debt are disorganized and rely on subjective assessments. This subjective analysis of what technical debt is, and where it occurs, is not only resource-intensive but is also prone to inaccuracies and oversight, given the complex nature of modern software systems and architectures. The reliance on ad hoc techniques for the identification, documentation, and management of technical debt significantly contributes to operational inefficiencies, making it challenging to prioritize and address issues in a timely and effective manner. Despite the widespread recognition of these challenges, many organizations struggle to find scalable and accurate solutions for managing technical debt, often due to the lack of comprehensive tools and models designed for this purpose.

Given these circumstances, there are opportunities for the development of improved platforms and technologies that offer more effective solutions for assessing, identifying, and managing technical debt, thereby addressing the identified conventional problems in the current landscape of technology management and software development.

### BRIEF SUMMARY OF THE INVENTION

In one aspect, a system for evaluating and managing technological debt in a technical environment includes: (1) a data acquisition system configured to acquire data from multiple sources including process information, technology information, governance information, and a tech ecosystem; (2) an analysis system configured to integrate and analyze the acquired data, wherein the analysis system is adapted for (i) evaluating operational procedures within the tech ecosystem based on the process information, (ii) assessing the technical foundation of the system based on the technology information, (iii) incorporating and evaluating governance information to ensure compliance with regulatory standards, (iv) analyzing the tech environment to understand its impact, (v) incorporating industry knowledge to align the assessment with current trends and standards, (vi) evaluating new tools and technologies to identify opportunities for modernization; and (3) an intelligent assessment system configured to synthesize the analyzed data to assess technical debt within the ecosystem and identify areas for improvement; (4) a management strategy system configured to generate actionable strategies based on the assessment of technical debt, wherein the strategies include at least a detailed report of technical debts by applications, a report of technical debts by business functions, an interactive chatbot for stakeholder engagement, and a dashboard for visualizing tech debt data and progress in addressing identified debts.

In another aspect, a computer-implemented method for evaluating and managing technological debt in a technical environment includes: (1) evaluating operational procedures within a tech ecosystem based on the process information; (2) assessing the technical foundation of the system based on the technology information; (3) incorporating and evaluating governance information to ensure compliance with regulatory standards; (4) analyzing the technical environment to understand its impact; (5) incorporating industry knowledge to align the assessment with current trends and standards; (6) evaluating new tools and technologies to identify opportunities for modernization; (7) synthesizing the analyzed data to assess technical debt within the ecosystem and identify areas for improvement; and (8) generating actionable strategies based on the assessment of technical debt, wherein the strategies include at least a detailed report of technical debts by applications, a report of technical debts by business functions, an interactive chatbot for stakeholder engagement, and a dashboard for visualizing tech debt data and progress in addressing identified debts.

In yet another aspect, a non-transitory computer-readable medium includes instructions that, when executed, cause a computer to: (1) evaluate operational procedures within a tech ecosystem based on the process information; (2) assess the technical foundation of the system based on the technology information; (3) incorporate and evaluate governance information to ensure compliance with regulatory standards; (4) analyze the technical environment to understand its impact; (5) incorporate industry knowledge to align the assessment with current trends and standards; (6) evaluate new tools and technologies to identify opportunities for modernization; (7) synthesize the analyzed data to assess technical debt within the ecosystem and identify areas for improvement; and (8) generate actionable strategies based on the assessment of technical debt, wherein the strategies include at least a detailed report of technical debts by applications, a report of technical debts by business functions, an interactive chatbot for stakeholder engagement, and a dashboard for visualizing tech debt data and progress in addressing identified debts.

### BRIEF DESCRIPTION OF THE DRAWINGS

The figures described below depict various aspects of the system and methods disclosed herein. It should be understood that each figure depicts an embodiment of a particular aspect of the disclosed system and methods, and that each of the figures is intended to accord with a possible embodiment thereof. There are shown in the drawings arrangements which are presently discussed, it being understood, however, that the present embodiments are not limited to the precise arrangements and instrumentalities shown.

FIG. 1 describes a computing environment for evaluating and managing technological debt in a technical environment, according to some aspects.

FIG. 2 depicts a block diagram of an intelligent assessor system, according to some aspects.

FIG. 3 depicts a block flow diagram corresponding to FIG. 2, according to some aspects.

FIG. 4 depicts a block flow diagram corresponding to FIG. 2, according to some aspects.

FIG. 5 depicts a block flow diagram corresponding to FIG. 2, according to some aspects.

FIG. 6 depicts a block flow diagram corresponding to FIG. 2, according to some aspects.

FIG. 7 depicts a block flow diagram corresponding to FIG. 2, according to some aspects.

FIG. 8 depicts a block flow diagram corresponding to FIG. 2, according to some aspects.

FIG. 9 depicts a block flow diagram corresponding to FIG. 2 and FIG. 8, according to some aspects.

FIG. 10 depicts a computer-implemented method for evaluating and systematically addressing technological debt in a technical environment, according to some aspects.

FIG. 11A depicts a block-flow diagram outlining a method 1100 for assessing and managing technical debt through an artificial intelligence model, particularly a language learning model (LLM), according to some aspects.

FIG. 11B illustrates a transformer-based model architecture for processing tokenized training text, according to some aspects.

### DETAILED DESCRIPTION

The present techniques may include methods and systems for assessing, identifying, and tracking technical debt while ensuring adherence to a well-architected framework across various technology ecosystems, and more particularly, training and operating one or more artificial intelligence (AI) models to analyze inputs such as code repositories, application architecture diagrams, and process flows. By integrating inputs with guidelines from well-architected frameworks and technology ecosystem knowledge, the present techniques effectively identify gaps and documents in existing technical debt. This process streamlines the assessment of technical debt, and may include classifying technical debt into categories (e.g., application debt, enterprise debt, etc.) providing clear distinctions based on the nature and scope of the debt.

Organizations today face the daunting challenge of keeping pace with the rapid evolution of technology. Legacy applications, suboptimal designs, and infrastructural inadequacies contribute to technical debt, which generally hampers an organization's ability to innovate and remain competitive. Technical debt may manifest in various forms, including increased maintenance costs, integration difficulties, and compromised agility. Technical debt can severely impact developer productivity, as resources are diverted from feature development to addressing existing issues. The present techniques may address these challenges by offering solutions that not only identify and track technical debt but also provide actionable insights for the management of technical debt.

The present techniques improve processing capabilities. By employing AI and machine learning algorithms, the system is able to marshal and process data from a multitude of data sources, including technical documents, code repositories, and architecture diagrams. By marshaling data across an organization, the present techniques improve thoroughness and accuracy in the assessment of technical debt, by identifying vulnerabilities and optimization opportunities that may have been otherwise overlooked. In some aspects, one or more generative AI (GenAI) models may be trained and used to further enhance the evaluation of technical debt, by synthesizing information from various inputs, thereby providing a comprehensive overview of the technical debt landscape on an organization-wide basis. Further, by analyzing these inputs, the system may classify identified technical debt, based on predefined criteria. This classification improves organizational software teams that are tasked with understanding the nature and scope of technical debt, enabling targeted strategies for mitigation and management.

In addition to these technical improvements, the system offers several functional benefits. It provides a tech debt assessment report detailing the current state of technical debt within the organization, offering valuable insights for stakeholders. Moreover, the system features a dashboard for visualizing technical debt across the organization, enhancing transparency and facilitating effective management. These features, combined with the system's ability to analyze adherence to a well-architected framework, make it a powerful tool for organizations seeking to manage and mitigate technical debt.

The present techniques address a challenge faced by many organizations: the accumulation of technical debt that hinders agility, increases maintenance costs, and poses risks to system stability and security. By providing a systematic and AI-powered approach to technical debt assessment, the present techniques enable organizations to identify, classify, and track technical debt more effectively. This, in turn, supports strategic decision-making, improves operational efficiency, and enhances the overall technology landscape of the organization.

### Exemplary Computing Environment

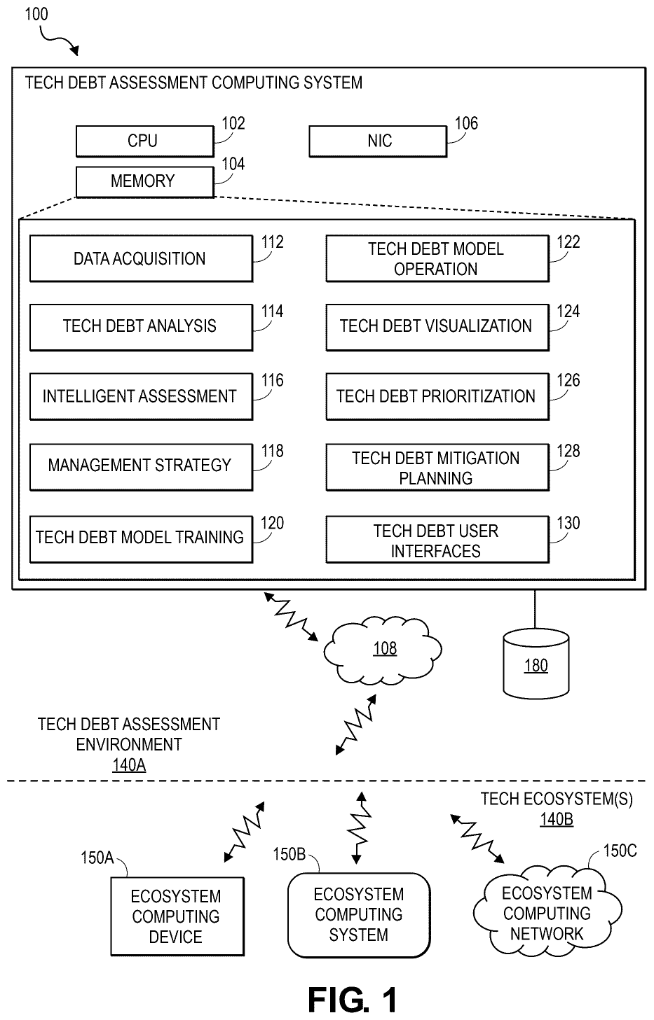

FIG. 1 describes a computing environment for evaluating and managing technological debt in a technical environment, according to some aspects. The computing environment includes a computing system 100 that includes a processor 102, a memory 104, and a network interface controller (NIC) 106 that may facilitate communication of the system 200 via an electronic network 108 to other components. The processor 102 may include any number of processors and/or processor types, such as central processing units (CPUs), graphics processing units (GPUs), field-programmable gate arrays (FPGAs), application-specific integrated circuits (ASICs), digital signal processors (DSPs), and the like. Generally, the processor 102 is configured to execute software instructions stored in the memory 104. The memory 104 may include volatile and/or non-volatile fixed and/or removable memory, such as read-only memory (ROM), electronic programmable read-only memory (EPROM), random access memory (RAM), and others. The memory 104 may have stored thereon one or more sets of non-transitory computer-executable instructions, that when executed by the processor 102, may cause one or more operations to occur. The NIC 106 may include any suitable network interface controller(s), such as wired/wireless controllers, and facilitate bidirectional/multiplexed networking over the network between the computing environment and external sources.

The memory 104 includes a plurality of modules 110, each including a respective set of computer-executable instructions. A data acquisition module 112 is configured to acquire data from multiple sources including process information, technology information, governance information, and a tech ecosystem. An analysis module 114 integrates and analyzes the acquired data, evaluating operational procedures within the tech ecosystem based on the process information, assessing the technical foundation of the system based on the technology information, incorporating and evaluating governance information to ensure compliance with regulatory standards, and analyzing the tech environment to understand its impact. The tech debt analysis module 114 also incorporates industry knowledge to align the assessment with current trends and standards, and evaluates new tools and technologies to identify opportunities for modernization. An intelligent assessment module 116 synthesizes the analyzed data to assess technical debt within the ecosystem and identify areas for improvement. A management strategy module 118 generates actionable strategies based on the assessment of technical debt, including at least a detailed report of technical debts by applications, a report of technical debts by business functions, an interactive chatbot for stakeholder engagement, and a dashboard for visualizing tech debt data and progress in addressing identified debts. A tech debt model training module 120 and a tech debt model operation module 122, respectively, train and operate machine learning models, such as neural networks and language models, to identify, assess, and mitigate technical debt. The tech debt model training module 120 prepares the machine learning models by using historical data and patterns related to technical debt, ensuring that the models are well-equipped to recognize and evaluate technical debt in various forms.

For example, the tech debt model training module 120 may train one or more machine learning models (e.g., one or more language models, one or more neural networks, etc.) using historical information from various sources, including process Information, such as historical data from business requirement documents, functional requirement documents, and process documents such as process flow diagrams. This information helps the model to understand the operational processes within the tech ecosystem, identifying inefficiencies, or areas for improvement that may contribute to technical debt. In some aspects, the tech debt model training module 120 may train the one or more models using technology Information, such as historical data concerning the technical stack, including hardware and software configurations, architectures, and technologies in use, are analyzed. The models may learn to identify areas where outdated or inefficient technologies may be contributing to technical debt. The tech debt model training module 120 may train the one or more models using governance information, including historical organizational policies, procedures, compliance regulations, and best practices. This training helps the model to align the technology environment with governance standards, and to manage technical debt by ensuring compliance and identifying areas where governance misalignment may contribute to debt. The tech debt model training module 120 may train the model using organizational redesign information, such as historical information on organizational structures and redesign initiatives is analyzed to understand their impact on the assessment and management of technical debt. The tech debt model training module 120 may train the models using industry knowledge and new tools and technologies. For example, the system 100 may integrate historical industry knowledge and information on new tools and technologies. This includes industry trends, standards, and technological advancements that can help in managing technical debt by incorporating modern solutions and aligning with industry practices.

The system 100 automates the assessment of technical debt, a complex issue that consumes a significant portion of technology budgets and professional time. By automating this process, the system seeks to reduce complexity and time spent managing technical debt. An example illustrating the practical benefits and effectiveness of the system involves its application in managing upgrades for software solutions. For instance, if a solution is currently on Python 2.6 and needs to be upgraded to Python 3.4, the system can automatically assess the technical debt associated with this upgrade. It evaluates the features and capabilities of the new version, identifies gaps in the current implementation, and documents the technical debt. This significantly reduces effort required for such assessments, streamlines the upgrade process, and ensures that decisions are made based on comprehensive and accurate information and systematically instead of in a disorganized, ad hoc fashion. The training data used for the machine learning model may include code repositories, architecture diagrams, process flows, and compliance with well-architected frameworks. These inputs are standardized across different cloud enterprises and on-premises solutions, ensuring a broad applicability of the model. The architecture of the machine learning model is based on neural networks and generative AI models, which are selected based on efficiency, data classification, and the sensitivity of the application. The system employs a combination of models to process images and text, extracting relevant information and classifying technical debt into categories such as application debt or enterprise debt. Evaluation metrics for the system may include the accuracy of technical debt identification, classification, and the effectiveness of recommendations for addressing identified debts. These metrics are crucial for continuously improving the system's performance and ensuring that it provides valuable insights for managing technical debt efficiently.

The tech debt model operation module 122 actively applies these trained models to ongoing projects and systems within the technical environment, providing real-time analysis and recommendations for addressing technical debt. The system 100 further includes a tech debt visualization module 124, a tech debt prioritization module 126, and a tech debt mitigation planning module 128. The tech debt visualization module 124 generates intuitive, visual representations of the technical debt landscape within the organization, making it easier for stakeholders to understand the severity and distribution of technical debt. The tech debt prioritization module 126 uses criteria such as impact on system performance, security vulnerabilities, and business goals to rank technical debts, helping teams to focus on the most critical issues first. The tech debt mitigation planning module 128 offers strategic guidance on addressing technical debt, including resource allocation, timelines, and potential trade-offs, facilitating a structured approach to reducing technical debt over time. In some aspects, the modules 110 may include hardware-specific instructions, such as instructions for executing one or more trained language models on a GPU. In some aspects, the system 100 may include a tech debt user interfaces module 130 that generates one or more user interfaces for display (e.g., via a web portal, via a mobile application, etc.).

The NIC 106 enables network connectivity, and may include a controller chip that acts as the central processing unit, managing data transmission and reception, handling error checking, and executing network protocol operations. The NIC may also include a bus interface that connects the NIC to the system 200, facilitating communication between the network 108 and the system 200. The NIC 106 may include includes Ethernet ports that provide the physical connection points for network cables and may include wireless communication components, such as antennas and transceivers for Wi-Fi connectivity. The NIC 106 may include additional functionality, in some aspects.

The electronic network 108 may connect the system 100 and facilitates its interaction with external data sources and users. The network 108 may include both physical and virtual components that together enable the transmission of data across the system 100. The physical components of the electronic network 108 may include one or more servers that store and process data, routers and switches that direct data traffic, and cabling and/or wireless technology infrastructure that links these devices. The virtual components may include software such as network operating systems, network management tools, and communication protocols that ensure data is transmitted securely and arrives at its intended destination within the system 100. The data acquisition module 112 may access the network 108 to collect data from a wide range of sources, including internal systems, databases, and online resources.

The electronic network 108 enables user interaction with system 100 through various interfaces, such as web portals or applications, allowing them to input data, configure settings, and view outputs like reports, dashboards, and interactive chatbots via one or more APIs (not depicted). The network 108 ensures that interactions between users and the system are smooth and responsive, enhancing the user experience.

For example, the system 100 may be communicatively coupled to and/or include within its memory 104 an electronic database 132. The electronic database 132 may be designed to store and manage the data collected and generated by the system 100. The database 132 may consist of structured data, such as process information, technology information, governance information, and data from the tech ecosystem, as well as unstructured data, including industry reports, news articles, and technical documentation. The electronic database 132 may be optimized for rapid data retrieval and analysis, supporting the system's need to access historical and current data efficiently for the purpose of identifying, assessing, and mitigating technical debt. The design, structure and implementation of the electronic database 132 may be aligned with the requirements of the technical debt system.

For example, to implement the electronic database 132 within system 100, one or more database technologies may be utilized, such as a relational database management system (RDBMS) (e.g., MySQL, PostgreSQL, or Oracle Database); a NoSQL databases (e.g., MongoDB, Cassandra, or Couchbase) a graph database, an in-memory database, a time-series database, a cloud-based database, etc.

The computing environment of FIG. 1 may be logically divided according to a tech debt assessment environment 140A, and one or more tech ecosystems 140B, in some aspects. The tech debt assessment environment 140A may include the system 100 and its components. For example, the tech ecosystems 140B may include one or more components that are evaluated for technical debt levels. The one or more tech ecosystems 140B may include one or more ecosystem computing device 150A, one or more ecosystem computing services 150B, and/or one or more ecosystem computing networks 150C. Of course, depending upon the environment in which the system 100 is deployed, the one or more tech ecosystems 140B may include more or fewer (or different) components 150. For example, the components 150 may include various interconnected components that work together, such as operating systems, applications, and development tools that enable devices to perform tasks and provide functionality to users; network infrastructure including local area networks (LAN), wide area networks (WAN), the internet, and wireless networks; data that is processed, stored, and transmitted by the computing ecosystem, including databases, data warehouses, and big data platforms; security components such as encryption software/devices, firewalls, and antivirus software; cloud/remote servers and services that provide scalable computing resources, storage, and applications over the internet; middleware such as APIs and message brokers/queues; user interfaces including graphical user interfaces (GUIs), command-line interfaces (CLIs), and voice interfaces; hardware and solutions for saving data, such as hard drives, solid-state drives (SSDs), network-attached storage (NAS), and cloud storage; integration services; support/maintenance services including technical support, software updates, and hardware maintenance; and standards and protocols. Any of the foregoing devices, services, networks, etc. may contribute to technical debt, and may be modified to mitigate that debt using the present techniques.

One or more components of the computing environment of FIG. 1 may be implemented as cloud-based services. For example, the electronic database 132 may be hosted on a cloud platform such as Amazon Web Services (AWS), Google Cloud Platform (GCP), or Microsoft Azure, leveraging scalable storage solutions and managed database services like Amazon RDS or Google Cloud SQL. This cloud-based implementation allows for dynamic scaling to accommodate varying loads and data volumes, ensuring that the system can efficiently handle the extensive data analysis required for evaluating and managing technological debt. Additionally, merely for example, the tech debt model training module 120 and the tech debt model operation module 122 may utilize cloud-based machine learning and AI services, such as AWS SageMaker or Google AI Platform, to train and deploy sophisticated models for identifying and mitigating technical debt. This cloud-based approach provides the flexibility and computational power needed to process large datasets and apply complex algorithms, enhancing the system's ability to deliver real-time insights and recommendations. It should be appreciated that the system 100 could utilize a public cloud, such as AWS, GCP, or Azure, to leverage their infrastructure and services for scalability and flexibility. Alternatively, a private cloud may be employed, offering more control over the environment and potentially enhanced security for sensitive data related to technological debt. A hybrid cloud approach may also be adopted, combining the benefits of both public and private clouds by keeping certain critical operations and data on-premises or in a private cloud for security and compliance reasons, while utilizing the public cloud for scalable computing resources and advanced services. This hybrid model allows for a balanced approach, optimizing the system's performance and security based on the specific needs of evaluating and managing technological debt.

In operation, the system 100 and its components, including the plurality of modules 110, work in concert to evaluate and manage technological debt in a technical environment, as discussed herein. The data acquisition module 112 acquires data from multiple sources, including process information, technology information, governance information, and a tech ecosystem. The data collected is analyzed to evaluate operational procedures within the tech ecosystem, assess the technical foundation of the system, incorporate and evaluate governance information, and analyze the technical environment to understand its impact. Specifically, the tech debt analysis module 114 integrates and analyzes the acquired data, incorporating industry knowledge and evaluating new tools and technologies. This may include incorporating industry knowledge to align the assessment with current trends and standards, and evaluating new tools and technologies to identify opportunities for modernization. The intelligent assessment module 116 synthesizes the analyzed data to assess technical debt within the ecosystem and identify areas for improvement. The output of the intelligent assessment module 116 provides an understanding of the technical debt landscape, enabling the identification of critical areas requiring attention. For generating actionable strategies based on the assessment of technical debt, the management strategy module 118 generates detailed reports of technical debts by applications and business functions. The management strategy module 118 also includes instructions that when executed, cause an interactive chatbot for stakeholder engagement to be generated and served via the system 100 (e.g., via an HTTP daemon process accessible via the network 108). The management strategy module 118 also includes instructions that, when executed, cause a dashboard for visualizing tech debt data and progress in addressing identified debts to be generated and served via the system 100 (e.g., via an HTTP daemon process accessible via the network 108). The outputs generated by the management strategy module 118 directly enable informed decision-making and strategic planning for mitigating technical debt. The tech debt model training module 120 and the tech debt model operation module 122 may respectively train and operate machine learning models, including neural networks and generative AI models, to process images and text, classify data, identify gaps and areas requiring updates, generate reports on regulatory compliance, and/or extract relevant information from various sources. The generative AI models enable summarizing and categorizing information from multiple inputs, identifying technological advancements suitable for integration, and refining assessments and recommendations through reinforcement learning with human feedback. The tech debt visualization module 124, the tech debt prioritization module 126, and the tech debt mitigation planning module 128 further support the method by—respectively—generating visual representations of the technical debt landscape, prioritizing technical debts based on various criteria, and offering strategic guidance on addressing technical debt. These modules enhance the system's ability to communicate the severity and distribution of technical debt, focus efforts on critical issues, and facilitate a structured approach to reducing technical debt over time. Each module within the system contributes to the execution of the method for evaluating and managing technological debt, ensuring a comprehensive, data-driven approach to identifying, assessing, and mitigating technical debt within a technical environment.

In operation, the interaction with system 100 varies significantly between end users and administrative users, each engaging with the system in ways that align with their roles and responsibilities in managing technological debt. For end users, their interaction primarily revolves around accessing and utilizing the outputs generated by system 100, and in configuring limited behaviors of the system 100. Once the data collection and processing/analysis phases are completed by the system, end users engage with the management strategy module 118 to access detailed reports, utilize interactive chatbots for stakeholder engagement, and view dashboards visualizing tech debt data and progress in addressing identified debts. These tools are designed to provide end users with insights into the technological debt landscape, enabling them to understand the severity, distribution, and implications of tech debt within their organization. End users can use the information presented in dashboards and reports to make informed decisions, participate in strategic discussions, and prioritize actions for tech debt mitigation. The chatbot serves as an interactive tool for end users to seek clarifications, ask questions, and receive guidance on tech debt management strategies.

In operation, end users can direct system 100 to analyze specific components or aspects of technical debt within their tech ecosystems 140B, focusing on particular ecosystem computing devices 150A, ecosystem computing services 150B, and/or ecosystem computing networks 150C. This targeted analysis allows end users to gain detailed insights into the technical debt associated with specific areas of their technological infrastructure, enabling more precise identification and prioritization of issues that need to be addressed. To initiate this focused analysis, an end user may interact with user interface functionality of the system 100 (e.g., as served via the tech debt user interfaces module 130), which may include a web portal, a desktop application, a mobile app, etc. Through this interface, the user can specify the components or aspects of technical debt they wish to analyze. This may involve selecting from a list of available ecosystem components 150, such as operating systems, applications, development tools, network infrastructure, databases, security components, cloud services, middleware, user interfaces, storage solutions, integration services, support/maintenance services, and standards and protocols. The user may also have the option to define custom components or aspects of the tech ecosystem that are of particular concern or interest (e.g., by typing in an IP address or other address enabling a zero configuration mechanism).

Once the components or aspects to be analyzed are specified, the system 100 utilizes its data acquisition module 112 to gather relevant data from the selected components. This may involve interfacing with ecosystem computing devices 150A, services 150B, and networks 150C to collect data on their operational performance, usage patterns, compliance with standards, security vulnerabilities, and any other relevant metrics that may indicate the presence and severity of technical debt.

The collected data is then processed and analyzed by the analysis module 114, which integrates the information and evaluates it in the context of the specified components or aspects. This analysis may include assessing the technical foundation of the selected components, evaluating their compliance with governance standards, analyzing their impact on the overall tech ecosystem, and identifying opportunities for modernization or improvement.

The results of this focused analysis are synthesized by the intelligent assessment module 116, which assesses the technical debt associated with the specified components and identifies areas for improvement. These insights are then presented to the end user through the management strategy module 118, which generates detailed reports, visualizations, and actionable strategies tailored to the specific components or aspects analyzed. This enables end users to understand the technical debt implications of their selected components and make informed decisions on prioritizing and addressing these issues.

Through this process, end users have the ability to direct system 100 to conduct targeted analyses of technical debt, focusing on specific components or aspects of their tech ecosystems. This capability allows for a more granular understanding of technical debt, facilitating effective management and mitigation strategies tailored to the unique needs and priorities of the organization.

Administrative users, on the other hand, have a more hands-on role with respect to system 100, involving both configuration and operational oversight. They may be responsible for setting up the data acquisition module 112, ensuring that it is correctly configured to gather the necessary data from various sources. This includes specifying what data to collect, scheduling data collection intervals, and ensuring the integration of data sources. Administrative users also oversee the operation of the tech debt model training module 120, providing historical data and patterns related to technical debt for training machine learning models. They monitor the performance of these models and adjust parameters as needed to improve accuracy and relevance.

Furthermore, administrative users play a role in customizing the system to meet the organization's specific needs. This includes configuring the tech debt visualization module 124, the tech debt prioritization module 126, and the tech debt mitigation planning module 128 to align with organizational priorities and goals. They adjust prioritization criteria, tailor mitigation strategies, and customize visualizations to ensure that the system's outputs are actionable and aligned with the organization's approach to managing technological debt.

### Exemplary Intelligent Technical Debt Assessor System

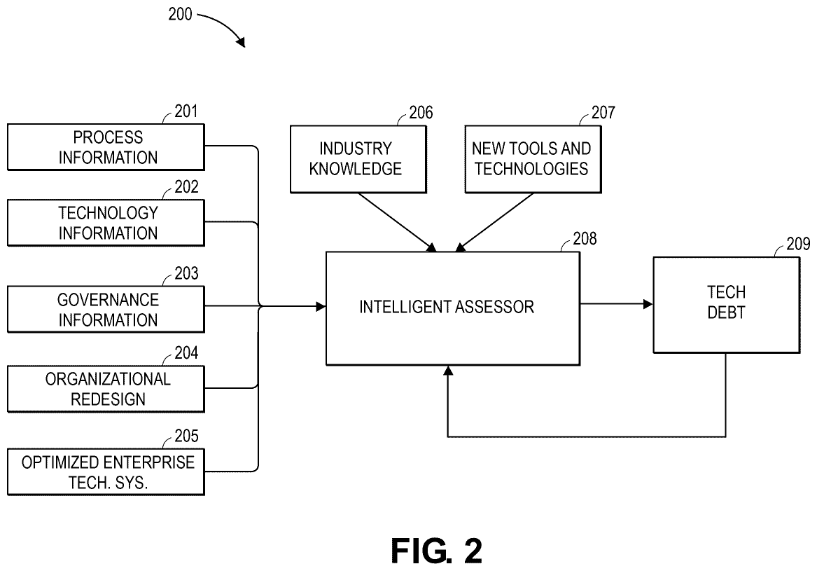

FIG. 2 depicts a block diagram of an intelligent assessor system 200 designed to evaluate technical environments by integrating various knowledge domains and data through an intelligent assessor to assess and manage technological debt, according to some aspects. In some aspects, the system 200 corresponds to the system 100 of FIG. 1.

The intelligent assessor system 200 acquires data from multiple sources: process information (block 201), technology information (block 202), governance information (block 203), organizational redesign information (block 204), and optimized enterprise technology systems information (block 205). These inputs include information sources that aid the intelligent assessor 208 in evaluating the existing technological framework.

The system 200 may use process information at block 201 to comprehend the operational procedures within the tech ecosystem, drawing from documents such as Standard Operating Procedures (SOPS) or flowcharts to identify inefficiencies or areas for improvement.

Technology information at block 202 involves detailed data concerning the technical stack, including hardware and software configurations, architectures, and technologies in use that characterize the technical aspects of the ecosystem.

Governance information at block 203 may include organizational policies, procedures, compliance regulations, and best practices to ensure the technology environment aligns with internal and external governance standards.

At blocks 204 and 205, related to tech ecosystem, the system may analyze specific the tech environment. At block 204, organizational redesign information is received into the system 200. Block 204 enables evaluating the existing technological framework within an organization, particularly in the context of managing technical debt. The system 200 acquires organizational redesign information using methods and systems detailed in U.S. patent application Ser. No. 18/764,861; entitled “Optimizing Enterprise Technology Ecosystems Using Artificial Intelligence to Analyze Data, Predict Stability, Identify Dependencies and Generate Actionable Tasks”, filed on Jul. 5, 2024 and hereby incorporated by reference in its entirety. In some aspects, the system 200 may receive optimization efficiency and stability information at block 205 using the methods and systems of U.S. patent application Ser. No. ______; entitled “______”, filed on ______ and hereby incorporated by reference in its entirety.

The information received at block 204 enables the system 200 to process and understand how the current organizational structure and redesign initiatives can impact the assessment and management of technical debt. The system 200, through block 204, analyzes the organizational redesign information to identify areas within the tech environment that may contribute to technical debt or areas where technical debt can be mitigated through strategic organizational changes. This analysis is part of a broader assessment that includes process information, technology information, governance information, and inputs from other blocks that contribute to a comprehensive understanding of the technical ecosystem. The inclusion of organizational redesign information allows the system 200 to consider the dynamic nature of organizational structures and the implications of redesign efforts on the technology landscape. By integrating this information, the system 200 can make more informed recommendations for managing technical debt, ensuring that the strategies devised are aligned with the organization's redesign objectives and parameters. Further, block 204 emphasizes the system's capability to leverage detailed methods and systems from other systems, enriching the assessment process with proven methodologies for organizational redesign. This integration ensures that the intelligent assessor system is equipped with the latest insights and strategies for evaluating and addressing technical debt in the context of organizational changes.

For example, the information received at block 205 enables the system 200 to process and understand the efficiency and stability of enterprise technology ecosystems, in particular, data across various layers of an enterprise's technology stack including relationships, stability predictions, and dependencies within the ecosystem. This may include data from multiple layers of an enterprise technology ecosystem, including actionable tasks for optimizing processes. This information may be available based on an event-triggered basis.

Additionally, the intelligent assessor system 200 interfaces with industry knowledge (block 206) and new tools & technologies (block 207), which impart further insight and modernization options for the assessment process. Data from blocks 206 and 207 may guide intelligent assessor 200 in incorporating the latest industry trends, standards, and technological advancements into the assessment.

An intelligent assessor (block 208) synthesizes all the acquired inputs from blocks 201, 202, 203, 204, 205, 206, and 207, employing these varied sources of knowledge to competently analyze and assess technical debt within the ecosystem.

The outcome of this assessment is conveyed to a module for managing tech debt (block 209), quantifying and addressing the accrued technological debts. It represents the actions, strategies, or plans devised to address the deficits in the technical environment based on the intelligent assessment.

Block 208, representing the intelligent assessor, is central, signifying its role as the core analysis unit receiving inputs from all other blocks and routing the assessed information to block 209.

The intelligent assessor system 200 demonstrates an integrated approach to evaluating the technical ecosystem, leveraging a combination of existing operational, technological, governance, and tech ecosystem information, along with industry knowledge and innovative tools to deliver comprehensive strategies for managing tech debt.

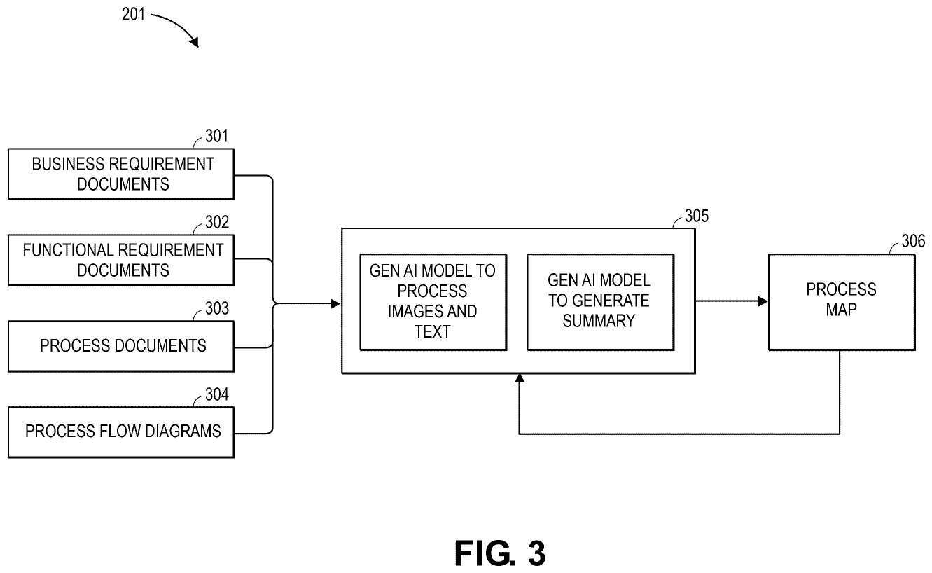

FIG. 3 depicts a block flow diagram corresponding to block 201 of FIG. 2, according to some aspects, and showing block 201 in greater detail. Block 201 defines a subprocess of the intelligent assessor system 200 that comprehends and analyzes the operational processes within a tech ecosystem. At block 201, the block flow diagram reveals the method by which system 200 ingests and processes various types of process-related documents to inform the assessment of technological debt. This includes business requirement documents (block 301), functional requirement documents (block 302), and process documents such as process flow diagrams (block 304). These documents serve to feed a generative AI model (block 305) capable of processing both images and text, which subsequently leads to the generation of a summarized interpretation of the operational processes.

The output of this generative AI processing may be a process map (block 306) that reflects the essential parameters and flow of operational processes, enhancing the understanding of the ecosystem's efficiency and potential areas for improvement. Block 201 embodies the intelligent assessor system 200's ability to systematically organize and interpret process information, which is fundamental for evaluating and managing technological debt. The generated process map at block 306 may serve as a foundation for identifying inefficiencies or optimizing existing processes, vital for maintaining the health of the tech environment.

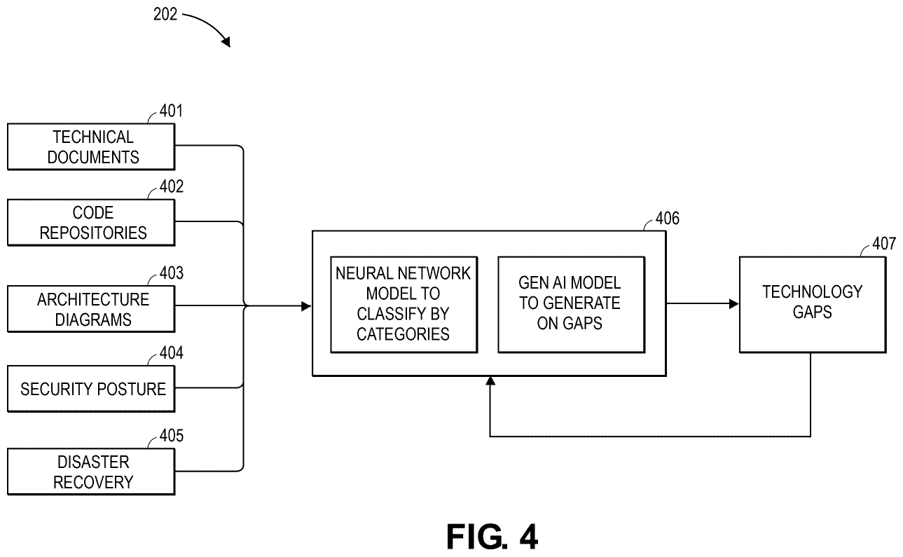

FIG. 4 depicts block flow diagram corresponding to block 202 of FIG. 2, according to some aspects, and showing block 202 in greater detail. Block 202 defines a subprocess of the intelligent assessor system 200 that evaluates the technical foundation of the system. At block 202, the block flow diagram depicts the system 200 method of consolidating technical data to assess the technological framework. This includes gathering technical documents (block 401), code repositories (block 402), architecture diagrams (block 403), security posture (block 404), and disaster recovery (block 405) plans. These elements provide a comprehensive perspective on the technical aspects such as software design, infrastructure, security measures, and contingency strategies.

The block 202 may include processing these elements using a neural network model to classify by categories (block 406) which categorizes the input data effectively. Following the categorization, a generative AI model (block 406) analyzes the data to generate gaps in the technology setup. The output of this processing may be the identification of technology gaps (block 407), which indicates areas that require improvement, updates, or reforms within the technical infrastructure.

Block 202 illustrates the capability of the intelligent assessor system 200 to analyze and identify the technical strengths and weaknesses by leveraging AI, ensuring that the technology environment is comprehensively reviewed. The output at block 407 represents the identified technology gaps that contribute to a strategic understanding of the necessary technological enhancements, serving as a precursor for planning upgrades and optimizing the technical ecosystem.

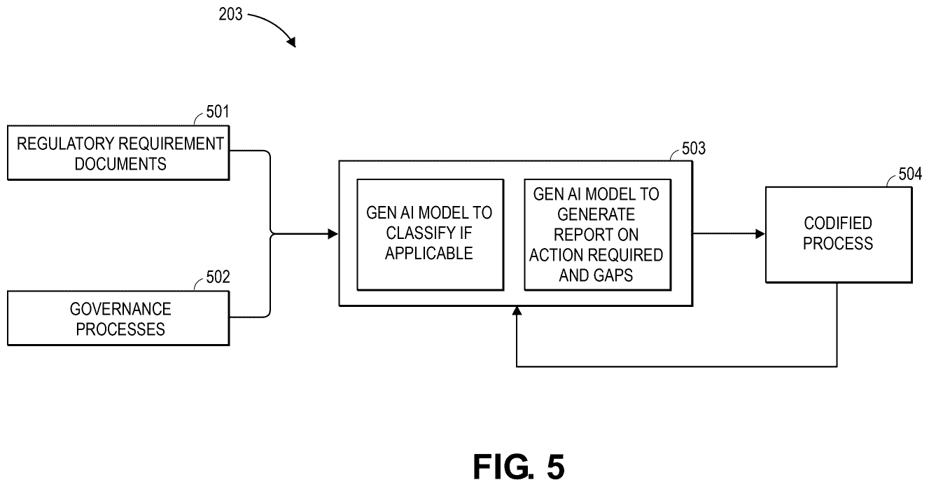

FIG. 5 depicts block flow diagram corresponding to block 203 of FIG. 2, according to some aspects, and showing block 203 in greater detail. Block 203 defines a subprocess of the intelligent assessor system 200 that incorporates and evaluates governance information. At block 203, the block flow diagram illustrates the method by which the system 200 handles regulatory and governance aspects within the technological ecosystem.

This includes receiving regulatory requirement documents (block 501), which may contain various compliance regulations, organizational policies, and governance standards. These documents are processed by a generative AI model to classify if applicable (block 502), thereby determining the relevance and applicability of the governance information to the technological environment under assessment.

Subsequently, another generative AI model generates a report detailing the actions required and identifying any gaps in governance (block 503). The output of these AI models ensures that the governance information is thoroughly analyzed to align the technology environment with governance processes and regulatory norms.

Ultimately, the processed information leads to a codified process (block 504), which may reflect standardized governance processes established on the insights gained from the AI models. Block 203 illustrates the capability of the intelligent assessor system 200 to integrate governance information effectively, ensuring compliance and best practices are ingrained within the technological assessment and management of technological debt.

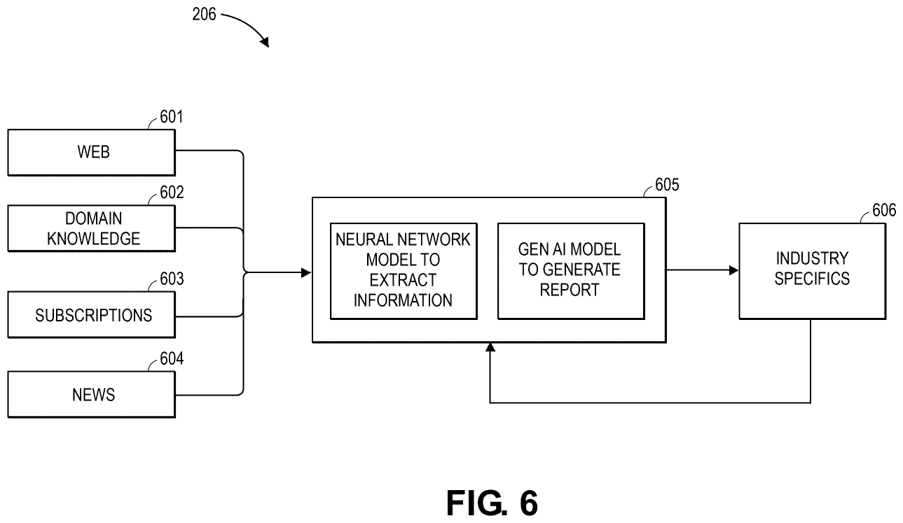

FIG. 6 depicts a detailed view corresponding to block 206 of FIG. 2, according to some aspects, and showing block 206 in greater detail. Block 206 defines the subprocess of the intelligent assessor system 200 that incorporates industry-specific knowledge for the assessment process. At block 206, the block flow diagram presents the method of integrating industry knowledge (block 605) with a neural network model to extract information (block 603) and a generative AI (Gen AI) model to generate a report (block 605), prior to obtaining the industry specifics (block 606).

The subprocess at block 206 begins with acquiring knowledge inputs from various sources such as web (block 601), domain knowledge (block 602), and subscriptions (block 603), as well as news sources (block 604). These inputs are processed by a neural network model (block 603) designed to extract pertinent information that will be useful for the industry-specific assessment. Following the extraction, a generative AI model (block 605) is used to synthesize the gathered data into a coherent report that adheres to industry standards and practices.

The culmination of this subprocess is the industry specifics (block 606) which are tailored outputs from block 206 that provide an informed foundation for the assessment and management of technological debt within a given tech ecosystem. Block 206 illustrates the capability of the intelligent assessor system 200 to incorporate real-time and relevant industrial knowledge into the assessment, enabling the assessor to consider the latest trends, standards, and advancements in technology which may impact the technology environment.

The detailed description of block 206, therefore, shows the importance of this subprocess in ensuring that the intelligent assessor system 200 remains up-to-date with industry-specific knowledge and can incorporate that into the assessments for better-informed management of technology debt.

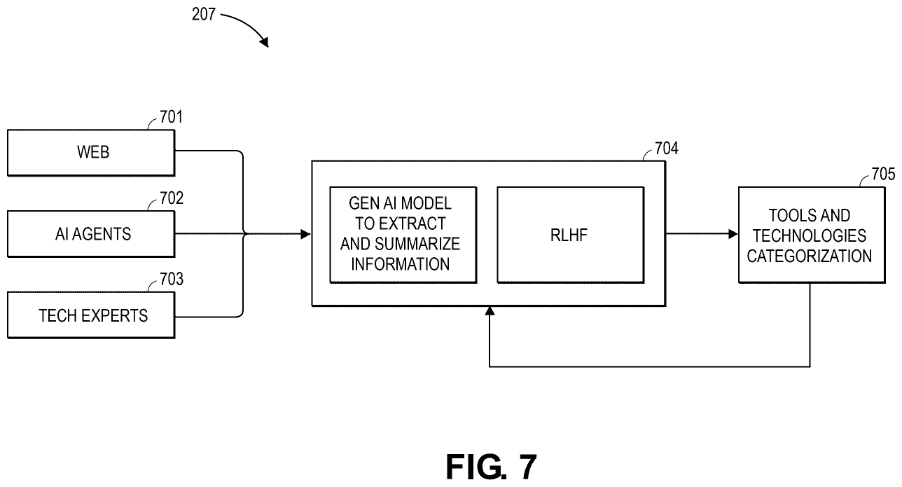

FIG. 7 depicts a block flow diagram corresponding to block 207 of FIG. 2, according to some aspects, showing block 207 in greater detail. Block 207 defines a subprocess of the intelligent assessor system 200 that evaluates new tools and technologies. At block 207, the block flow diagram illustrates the system's 200 method of processing new technology information. This includes sourcing data from the web (block 701), contributions from AI agents (block 702), and input from tech experts (block 703), each playing a role in providing current and emerging technology data. Block 207 may involve the use of a generative AI model (block 704) that extracts and summarizes information from these varied inputs, facilitating the intelligent assessor's understanding of cutting-edge tools and technological advancements.

The output of this generative AI processing is represented as a categorized list of tools and technologies (block 705), which may be used by the intelligent assessor to stay up-to-date with industry standards and implement modernization strategies within the assessment process. Block 207 indicates the capability of the intelligent assessor system 200 to assimilate diverse sources of technological data and updates, using a robust AI model to identify and categorize relevant tools, thus supporting informed decision-making related to technical environment improvements. The outcome at block 705 may serve as a reference point for incorporating contemporary technology solutions into the organization's tech ecosystem, ensuring the continuous evolution and optimization of the technical framework.

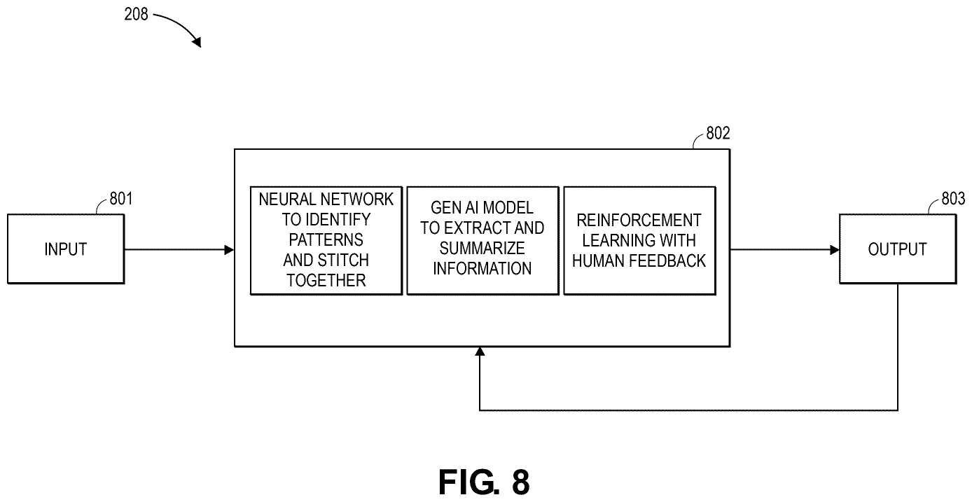

FIG. 8 depicts a block flow diagram corresponding to block 208 of FIG. 2, according to some aspects, and showing block 208 in greater detail. Block 208 defines a subprocess of the intelligent assessor system 200 that is designed for the evaluation and management of technological debt through the synthesis of various inputs. At block 208, the block flow diagram illustrates the method by which the intelligent assessor system systematically processes information. This includes identifying patterns and stitching together related information using a neural network (block 801), extracting and summarizing information with a general artificial intelligence model (block 802), and incorporating reinforcement learning with human feedback (block 803).

The process begins with input data that enters block 801, where a neural network works to identity patterns and stitch together information from diverse sources. The refined output from block 801 is then passed to block 802, wherein a general AI model is employed to extract and summarize the information, which is necessary for assessing the technological debt. The output from block 802 is further enhanced through block 803, which employs reinforcement learning with human feedback to ensure that the system's outputs are continuously improved and aligned with human expertise and judgment.

Block 208, therefore, serves as an advanced analytic engine within the intelligent assessor system 200, integrating and processing inputs from various aspects of the technological ecosystem to provide a coherent output to inform further processes or decision-making steps. The output of block 208 is ultimately used to guide the intelligent assessor system 200 in optimizing strategies for managing and reducing technological debt, as further detailed in the related block 209.

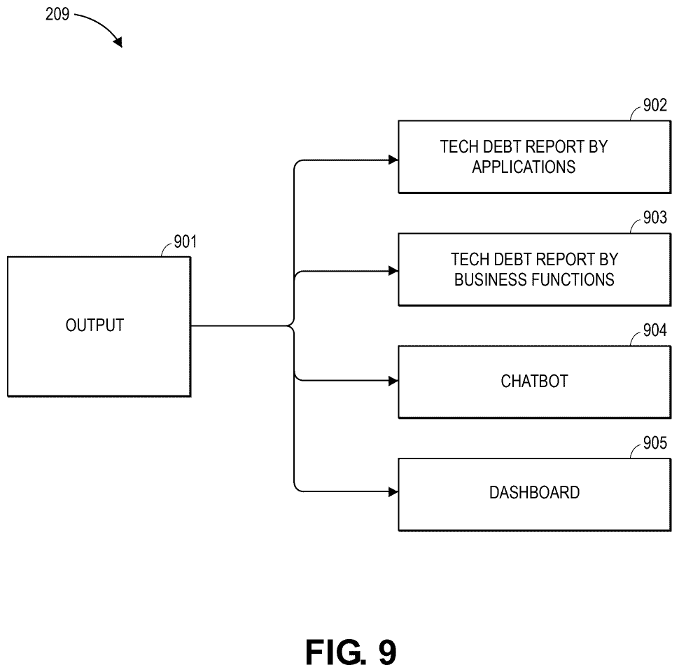

FIG. 9 depicts a detailed block diagram corresponding to block 209 of FIG. 2, according to some aspects, and showing block 209 in greater detail. Block 209 defines a subprocess of the intelligent assessor system 200 that manages tech debt by delivering various outputs based on the assessments made by the intelligent assessor. At block 209, the block diagram demonstrates the outputs that the system 200 provides to tackle the identified technological debts. These outputs include a tech debt report by applications (block 902), a tech debt report by business functions (block 903), a chatbot (block 904), and a dashboard (block 905).

The tech debt report by applications at block 902 may involve a detailed breakdown of technical debts associated with specific applications within the technical ecosystem. This reporting facilitates the understanding of how each application contributes to the overall tech debt and aids in prioritizing which debts to address based on criticality or potential impact.

Similarly, the tech debt report by business functions at block 903 includes a segmented analysis of tech debt as it relates to various business functions, possibly highlighting how technical inadequacies or obsolescence may be affecting different areas of the business. This output may guide strategic decisions and investments in areas that can most benefit from technology updates or process optimization.

The chatbot at block 904 represents an interactive tool that stakeholders can use to inquire about the tech debt landscape, receive updates, or query specific details from the reports. It may employ natural language processing and machine learning to provide intelligent and contextually relevant responses.

Finally, the dashboard at block 905 provides a visual representation of the tech debt data, incorporating analytics and perhaps real-time tracking metrics. This interface allows for quick insight into the current state of tech debt and can facilitate swift decision-making and monitoring progress on tech debt reduction initiatives.

Block 209, therefore, acts as the output generator within the intelligent assessor system 200, taking the comprehensive analysis provided by block 208 and translating it into actionable information and tools for managing technological debt. The manifold outputs from block 209 support an integrated approach to tech debt management, utilizing reports, interactive tools, and visual insights to manage and reduce the impact of tech debt on the organization.

The output block 901 of FIG. 9 may correspond to the output block 803 of FIG. 8, in some aspects.

### Exemplary Computer-Implemented Method for Assessing, Identifying and Tracking Technical Debt

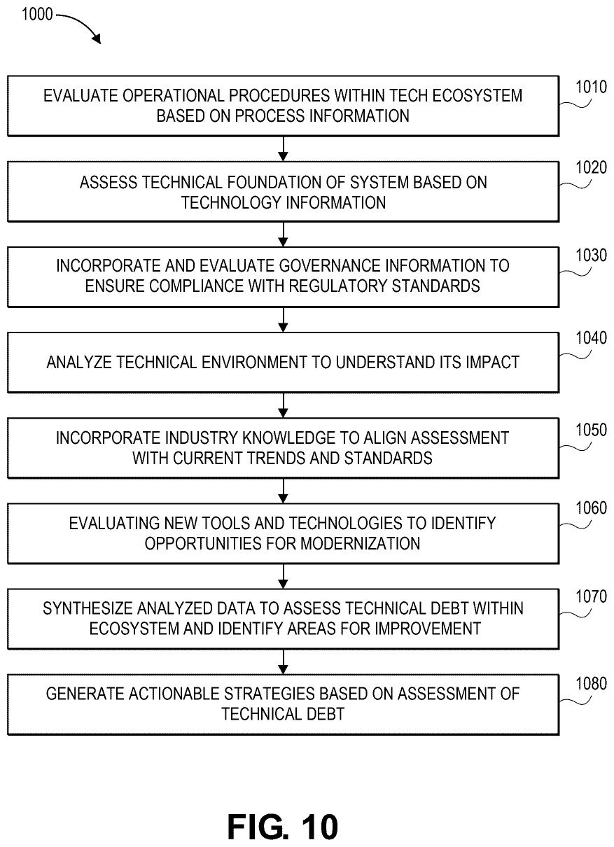

FIG. 10 depicts a computer-implemented method 1000 for evaluating and systematically addressing technological debt in a technical environment, according to some aspects. For example, the method 1000 may be performed by the system 100 of FIG. 1. The method 1000 enables stakeholders to evaluate, understand and mitigate the impacts of outdated or inefficient technology practices within an organization's tech ecosystem.

The method 1000 may include evaluating operational procedures within a tech ecosystem based on process information (block 1002). This step involves a thorough examination of the existing operational workflows and practices to identify inefficiencies, redundancies, or areas that may benefit from optimization. By scrutinizing the operational procedures, organizations can pinpoint critical areas where technological debt has accumulated and where improvements are necessary.

The method 1000 may further include assessing the technical foundation of the system based on technology information (block 1004). This involves analyzing the current technology stack, including hardware, software, and platforms, to determine their adequacy, scalability, and alignment with the organization's goals. This assessment helps in identifying outdated technologies that contribute to technical debt and in understanding the need for technological updates or enhancements.

The method 1000 may include incorporating and evaluating governance information to ensure compliance with regulatory standards (block 1006). This step ensures that the organization's technology practices are in line with relevant laws, regulations, and industry standards. By evaluating governance information, the method aids in identifying compliance gaps and recommending actions to mitigate risks associated with non-compliance.

The method 1000 may include analyzing the technical environment to understand its impact (block 1008). This includes examining the broader tech ecosystem in which the organization operates, including external factors such as market trends, competitor technologies, and regulatory changes. Understanding the external tech environment enables aligning the organization's technology strategy with industry standards and trends.

The method 1000 may include incorporating industry knowledge to align the assessment with current trends and standards (block 1010). This involves leveraging external sources of information, such as industry reports, expert analyses, and technological forecasts, to ensure that the assessment of technological debt is informed by the latest developments and best practices in the field.

The method 1000 may include evaluating new tools and technologies to identify opportunities for modernization (block 1012). This step focuses on identifying and assessing emerging technologies that may address existing technological debt and enhance the organization's technological capabilities. By staying abreast of new tools and technologies, organizations can make informed decisions about adopting innovations that offer strategic advantages.

The method 1000 may include synthesizing the analyzed data to assess technical debt within the ecosystem and identify areas for improvement (block 1014). This involves integrating insights from the previous steps to develop an understanding of the organization's technological debt landscape. This synthesis enables the identification of priority areas for improvement and the development of targeted strategies to address technological debt.

In some aspects, the method 1000 may include generating actionable strategies based on the assessment of technical debt (block 1016). This step involves creating detailed plans and recommendations for mitigating identified technological debts. The strategies may include a mix of short-term fixes and long-term initiatives, such as updating or replacing outdated systems, adopting new technologies, and revising operational procedures. The output of this step includes detailed reports of technical debts by applications and business functions, an interactive chatbot for stakeholder engagement, and a dashboard for visualizing tech debt data and progress in addressing identified debts. This approach ensures that stakeholders are well-informed and can track the progress of debt mitigation efforts effectively.

In some aspects, the method 1000 may include interfacing with external sources to gather industry knowledge and information on new tools and technologies to receive the latest advancements and trends. This feature allows the method 1000 to remain current and informed about the evolving technological landscape, ensuring that the evaluation and management of technological debt are based on the most recent information. This capability enhances the method's effectiveness by enabling the identification of new opportunities for modernization and ensuring that the strategies developed are aligned with current trends and standards.

In some aspects, the method 1000 may include processing, via a generative AI model, one or both of images and text to generate an understanding of operational efficiencies and deficiencies. This approach leverages advanced AI techniques to analyze operational procedures more deeply, identifying inefficiencies and areas for improvement that may not be apparent through traditional analysis methods. By automating the analysis of operational data, the method can uncover insights more quickly and accurately, leading to more effective strategies for addressing technological debt.

In some aspects, the method 1000 may include classifying, via one or more trained neural network models, data; and identifying, via one or more generative AI models, gaps and areas requiring technological updates or enhancements. This dual approach uses neural networks for precise data classification and generative AI models for gap identification, providing an analysis of the technical foundation. This enables a more targeted identification of outdated technologies and areas needing updates, improving the method's ability to recommend precise technological enhancements.

In some aspects, the method 1000 may include processing, via one or more generative AI models, regulatory requirements to generate reports highlighting compliance gaps and recommended actions. This feature automates the evaluation of governance information, making it easier to identify compliance issues and recommend actions to mitigate risks associated with non-compliance. By leveraging AI for regulatory analysis, the method enhances its ability to ensure that technological practices align with relevant laws and standards, thereby reducing legal and operational risks.

In some aspects, the method 1000 may include extracting, via one or more neural network models, relevant information from a plurality of sources including web publications, domain-specific knowledge bases, and news outlets. This capability enriches the method's assessment with a broad range of industry knowledge, ensuring that the evaluation of technological debt is informed by comprehensive and diverse insights. By integrating information from various sources, the method can align its assessment more closely with current trends and standards, leading to more effective management of technological debt.

In some aspects, the method 1000 may include summarizing and categorizing, via a generative AI model, information from a plurality of inputs to identify technological advancements suitable for integration into the technical environment. This feature streamlines the process of evaluating new tools and technologies, making it easier to identify those that offer significant benefits for modernization efforts. By automating the summarization and categorization of information, the method can more efficiently identify opportunities for technological enhancement, improving the organization's ability to address technological debt.

In some aspects, the method 1000 may include identifying, via a neural network trained to identify patterns, one or more artificial intelligence models for summarization; and refining, via a reinforcement learning with human feedback model, assessments and recommendations. This AI-driven approach enables the method to refine its assessments and recommendations continuously, ensuring that they remain accurate and relevant. By incorporating human feedback into the learning process, the method can adapt and improve over time, leading to more effective strategies for managing technological debt.

In some aspects, the method 1000 may include a chatbot including one or more natural language processing and machine learning models configured to facilitate dynamic interaction with stakeholders regarding the technological debt landscape and available mitigation strategies. This interactive feature enhances stakeholder engagement, providing a user-friendly platform for discussing technological debt issues and exploring potential solutions. By leveraging natural language processing and machine learning, the chatbot can offer personalized and informed responses, making it easier for stakeholders to understand and participate in the management of technological debt.

In summary, the method 1000 introduces a range of enhancements that significantly improve the system's and method's ability to evaluate and manage technological debt. By incorporating advanced AI models, interfacing capabilities, and interactive features, the invention offers a more comprehensive, accurate, and user-friendly approach to addressing technological debt in a technical environment. These enhancements enable an organization looking to optimize their technological practices and align with current trends and standards.

### Exemplary Language Model Architecture

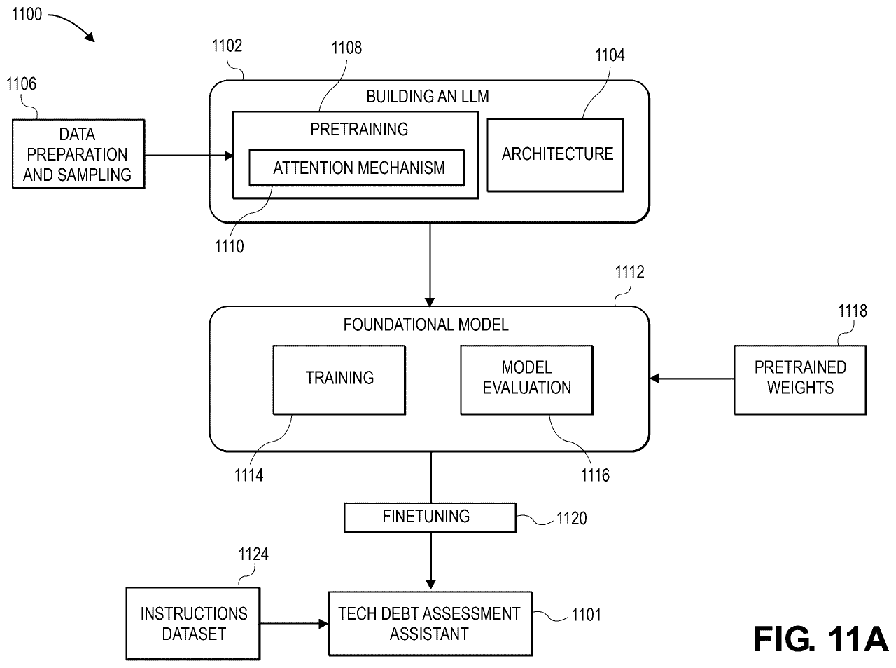

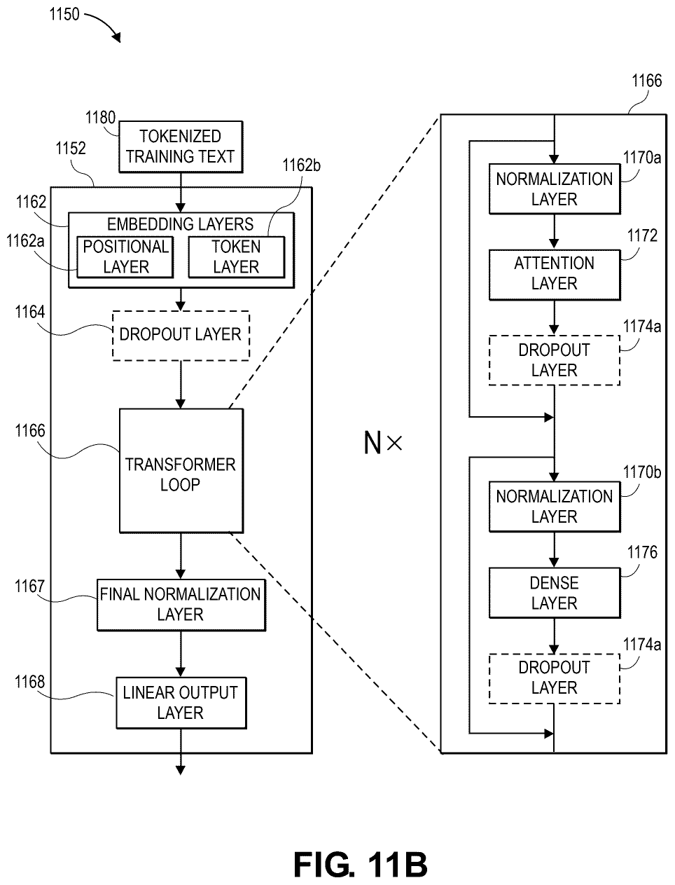

FIG. 11A depicts a block-flow diagram outlining a method 1100 for assessing and managing technical debt through an artificial intelligence model, particularly a language learning model (LLM), according to some aspects. Of course, as noted above, other models may be used, such as small language models, in some aspects. The method 1100 may include building and/or using an LLM to develop a technical debt assessment assistant.

The method 1100 includes data preparation and sampling which includes processing data for the purpose of understanding of the current technical environment and identifying areas that contribute to technical debt (block 1106). Next, the method 1100 includes building an LLM (block 1102) which includes pretraining with an attention mechanism (block 1108), and developing the architecture of the language model (block 1104). This pretraining phase includes creating a foundational model (block 1110) that learns from the prepared data to understand technical debt within the given technical ecosystem.

The foundational model (block 1112) includes further training (block 1114) and model evaluation (block 1116) steps. At this stage, the model may also be equipped with pretrained weights (block 1118), which can expedite the training process by leveraging pre-existing learned patterns and knowledge.

Following the completion of the foundational model, the process includes finetuning (block 1120), which is the final adjustment and optimization phase using more specific data related to technical debt. This step helps to tailor the LLM to accurately identify and assess technical debt within a range of technical environments.

Lastly, an instructions dataset (block 1124) feeds into the tech debt assessment assistant (block 1101). This dataset may include prompts and instructions in the context of technical debt that enable the LLM to provide pertinent analyses and responses. These prompts facilitate the practical application of the trained model, allowing it to effectively aid in the assessment and management of technical debt.

FIG. 11A represents a systematic approach to building a specialized LLM for the purpose of assessing and managing technical debt, starting from data preparation, through the model building with pretraining and architecture development, to the finetuning and application of a tech debt assessment assistant assisted by a structured instructions dataset. This illustration conceptualizes the flow of activities needed to create a tool that aids in the identification and management of technical debt within a technological ecosystem, according to some aspects.

FIG. 11B illustrates a neural network-based model architecture for processing and analyzing data related to technological debt (block 1152). The process begins with data collection (block 1180) which is then passed through preprocessing layers, specifically a data normalization layer (block 1162a) and a feature extraction layer (block 1162b). These layers are followed by a dropout layer (block 1164) to prevent overfitting. The core of the architecture is the neural network loop (block 1166), which is iterated N times, where N is a positive integer. Each iteration consists of a normalization layer (block 1170a), followed by an attention layer (block 1172) with its own dropout layer (block 1174a), another normalization layer (block 1170b), a dense layer (block 1176), and another dropout layer (block 1174b). The process concludes with a final normalization layer (block 1167) and a linear output layer (block 1168), producing the final output from the neural network-based model. This architecture is designed to handle and analyze data for identifying and managing technological debt.

The model architecture depicted in FIG. 11B may be used to analyze and evaluate technological debt, particularly in the context of identifying inefficiencies, compliance gaps, and opportunities for modernization. This neural network-based architecture facilitates the processing of diverse data through a series of layers and loops designed to understand and identify patterns related to technological debt effectively. Initially, the collected data is processed through preprocessing layers, including normalization and feature extraction layers, which help the model understand the significance of each data point within the context of technological debt. This is crucial for effectively managing technological debt as it allows the system to grasp the nuances of the organization's technical environment, including outdated technologies, compliance issues, and potential areas for improvement. The dropout layers introduced after the preprocessing layers and within the neural network loop serve to prevent overfitting by randomly omitting some of the units from the layers during training. This ensures that the model does not become too reliant on the training data, allowing it to generalize better to new, unseen data. The neural network loop, iterated N times, is where the bulk of the analysis happens. Each iteration consists of a series of layers including normalization, attention, and dense layers, each followed by dropout layers. The normalization layers help stabilize the learning process, while the attention layers allow the model to focus on different parts of the input data to better understand the relationships between various factors contributing to technological debt. The dense layers, on the other hand, are fully connected layers that help in learning non-linear combinations of the features. The final normalization layer ensures that the data is normalized before passing it to the linear output layer, which produces the final output of the model. This output can then be used for various tasks related to the management of technological debt, such as generating reports on technological debt by applications and business functions, as discussed above. In the context of managing technological debt, the analyzed data can inform the development of strategies for technological updates, compliance alignment, and operational optimization. By leveraging the neural network-based architecture, the system can synthesize complex data, identify patterns, and generate actionable insights for effectively managing technological debt. This process is facilitated by the system's ability to learn from vast amounts of data, identify patterns, and output strategic and data-driven plans for technological debt mitigation.

### Aspects

The various embodiments described above can be combined to provide further embodiments. All U.S. patents, U.S. patent application publications, U.S. patent application, foreign patents, foreign patent application and non-patent publications referred to in this specification and/or listed in the Application Data Sheet are incorporated herein by reference, in their entirety. Aspects of the embodiments can be modified if necessary to employ concepts of the various patents, applications, and publications to provide yet further embodiments.

These and other changes can be made to the embodiments in light of the above-detailed description. In general, in the following claims, the terms used should not be construed to limit the claims to the specific embodiments disclosed in the specification and the claims but should be construed to include all possible embodiments along with the full scope of equivalents to which such claims are entitled. Accordingly, the claims are not limited by the disclosure.

Aspects of the techniques described in the present disclosure may include any of the following aspects, either alone or in combination:
1. A system for evaluating and managing technological debt in a technical environment, the system comprising: (a) a data acquisition system configured to acquire data from multiple sources including process information, technology information, governance information, and a tech ecosystem; (b) an analysis system configured to integrate and analyze the acquired data, wherein the analysis system is adapted for: (i) evaluating operational procedures within the tech ecosystem based on the process information; (ii) assessing the technical foundation of the system based on the technology information; (iii) incorporating and evaluating governance information to ensure compliance with regulatory standards; (iv) analyzing the tech environment to understand its impact; (v) incorporating industry knowledge to align the assessment with current trends and standards; (vi) evaluating new tools and technologies to identify opportunities for modernization; and (c) an intelligent assessment system configured to synthesize the analyzed data to assess technical debt within the ecosystem and identify areas for improvement; (d) a management strategy system configured to generate actionable strategies based on the assessment of technical debt, wherein the strategies include at least a detailed report of technical debts by applications, a report of technical debts by business functions, an interactive chatbot for stakeholder engagement, and a dashboard for visualizing tech debt data and progress in addressing identified debts.
2. The system of aspect 1, wherein the data acquisition system further includes capabilities for interfacing with external sources to gather industry knowledge and information on new tools and technologies to receive latest advancements and trends.
3. The system of any of aspects 1-2, wherein the analysis system for evaluating operational procedures includes a generative AI model processing at least one of (i) images, (ii) text, (iii) audio, or (iv) video to generate an understanding of operational efficiencies and deficiencies.
4. The system of any of aspects 1-3, wherein the analysis system for assessing the technical foundation includes one or more trained neural network models for data classification and one or more generative AI models for identifying gaps and areas requiring technological updates or enhancements.
5. The system of any of aspects 1-4, wherein the analysis system for incorporating and evaluating governance information includes one or more generative AI models to analyze regulatory requirements and generate reports highlighting compliance gaps and recommended actions.
6. The system of any of aspects 1-5, wherein the analysis system for incorporating industry knowledge includes one or more neural network models trained to extract relevant information from a plurality of sources, including web publications, domain-specific knowledge bases, and news outlets.
7. The system of any of aspects 1-6, wherein the analysis system for evaluating new tools and technologies comprises a generative AI model designed to summarize and categorize information from diverse inputs, aiding in the identification of technological advancements suitable for integration into the technical environment.
8. The system of any of aspects 1-7, wherein the intelligent assessment system includes a neural network trained to identify patterns, one or more artificial intelligence models for summarization, and a reinforcement learning with human feedback model to refine assessments and recommendations.
9. The system of any of aspects 1-8, wherein the management strategy system includes a chatbot including one or more natural language processing and machine learning models to facilitate dynamic interaction with stakeholders regarding the technological debt landscape and available mitigation strategies.
10. A computer-implemented method for evaluating and managing technological debt in a technical environment, the method comprising: (i) evaluating operational procedures within a tech ecosystem based on the process information; (ii) assessing the technical foundation of the system based on the technology information; (iii) incorporating and evaluating governance information to ensure compliance with regulatory standards; (iv) analyzing the technical environment to understand its impact; (v) incorporating industry knowledge to align the assessment with current trends and standards; (vi) evaluating new tools and technologies to identify opportunities for modernization; (vii) synthesizing the analyzed data to assess technical debt within the ecosystem and identify areas for improvement; and (viii) generating actionable strategies based on the assessment of technical debt, wherein the strategies include at least a detailed report of technical debts by applications, a report of technical debts by business functions, an interactive chatbot for stakeholder engagement, and a dashboard for visualizing tech debt data and progress in addressing identified debts.
11. The computer-implemented method of aspect 10, further comprising: interfacing with external sources to gather industry knowledge and information on new tools and technologies to receive latest advancements and trends.
12. The computer-implemented method of any of aspects 10-11, further comprising: processing, via a generative AI model, at least one of (i) images, (ii) text, (iii) audio, or (iv) video to generate an understanding of operational efficiencies and deficiencies.
13. The computer-implemented method of any of aspects 10-12, further comprising: classifying, via one or more trained neural network models, data; and identifying, via one or more generative AI models, gaps and areas requiring technological updates or enhancements.
14. The computer-implemented method of any of aspects 10-13, further comprising: processing, via one or more generative AI models, regulatory requirements to generate reports highlighting compliance gaps and recommended actions.
15. The computer-implemented method of any of aspects 10-14, further comprising: extracting, via one or more neural network models, relevant information from a plurality of sources including web publications, domain-specific knowledge bases, and news outlets.
16. The computer-implemented method of any of aspects 10-15, further comprising: summarizing and categorizing, via a generative AI model, information from a plurality of inputs to identify technological advancements suitable for integration into the technical environment.
17. The computer-implemented method of any of aspects 10-16, further comprising: identifying, via a neural network trained to identify patterns, one or more artificial intelligence models for summarization, and refining, via a reinforcement learning with human feedback model, assessments and recommendations.
18. The computer-implemented method of any of aspects 10-17, further comprising: a chatbot including one or more natural language processing and machine learning models configured to facilitate dynamic interaction with stakeholders regarding the technological debt landscape and available mitigation strategies.
19. A non-transitory computer-readable medium having stored thereon computer-executable instructions that, when executed, cause a computer to: (i) evaluate operational procedures within a tech ecosystem based on the process information; (ii) assess the technical foundation of the system based on the technology information; (iii) incorporate and evaluating governance information to ensure compliance with regulatory standards; (iv) analyze the technical environment to understand its impact; (v) incorporate industry knowledge to align the assessment with current trends and standards; (vi) evaluate new tools and technologies to identify opportunities for modernization; (vii) synthesize the analyzed data to assess technical debt within the ecosystem and identify areas for improvement; and (viii) generate actionable strategies based on the assessment of technical debt, wherein the strategies include at least a detailed report of technical debts by applications, a report of technical debts by business functions, an interactive chatbot for stakeholder engagement, and a dashboard for visualizing tech debt data and progress in addressing identified debts.
20. The non-transitory computer-readable medium aspect 19, having stored thereon computer-executable instructions that, when executed, cause a computer to: process, via a generative AI model, at least one of (i) images, (ii) text, (iii) audio, or (iv) video to generate an understanding of operational efficiencies and deficiencies.

### Additional Considerations

The following considerations also apply to the foregoing discussion. Throughout this specification, plural instances may implement operations or structures described as a single instance. Although individual operations of one or more methods are illustrated and described as separate operations, one or more of the individual operations may be performed concurrently, and nothing requires that the operations be performed in the order illustrated. These and other variations, modifications, additions, and improvements fall within the scope of the subject matter herein.

It should also be understood that, unless a term is expressly defined in this patent using the sentence “As used herein, the term” “is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based on the application of 35 U.S.C. § 112(f).

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of “a” or “an” is employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for implementing the concepts disclosed herein, through the principles disclosed herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A system for evaluating and managing technological debt in a technical environment, the system comprising:
(a) a data acquisition system configured to acquire data from multiple sources including process information, technology information, governance information, and a tech ecosystem;
(b) an analysis system configured to integrate and analyze the acquired data, wherein the analysis system is adapted for:
(i) evaluating operational procedures within the tech ecosystem based on the process information;
(ii) assessing the technical foundation of the system based on the technology information;
(iii) incorporating and evaluating governance information to ensure compliance with regulatory standards;
(iv) analyzing the tech environment to understand its impact;
(v) incorporating industry knowledge to align the assessment with current trends and standards;
(vi) evaluating new tools and technologies to identify opportunities for modernization; and
(c) an intelligent assessment system configured to synthesize the analyzed data to assess technical debt within the ecosystem and identify areas for improvement;
(d) a management strategy system configured to generate actionable strategies based on the assessment of technical debt, wherein the strategies include at least a detailed report of technical debts by applications, a report of technical debts by business functions, an interactive chatbot for stakeholder engagement, and a dashboard for visualizing tech debt data and progress in addressing identified debts.

2. The system of claim 1, wherein the data acquisition system further includes capabilities for interfacing with external sources to gather industry knowledge and information on new tools and technologies to receive latest advancements and trends.

3. The system of claim 1, wherein the analysis system for evaluating operational procedures includes a generative AI model processing at least one of (i) images, (ii) text, (iii) audio, or (iv) video to generate an understanding of operational efficiencies and deficiencies.

4. The system of claim 1, wherein the analysis system for assessing the technical foundation includes one or more trained neural network models for data classification and one or more generative AI models for identifying gaps and areas requiring technological updates or enhancements.

5. The system of claim 1, wherein the analysis system for incorporating and evaluating governance information includes one or more generative AI models to analyze regulatory requirements and generate reports highlighting compliance gaps and recommended actions.

6. The system of claim 1, wherein the analysis system for incorporating industry knowledge includes one or more neural network models trained to extract relevant information from a plurality of sources, including web publications, domain-specific knowledge bases, and news outlets.

7. The system of claim 1, wherein the analysis system for evaluating new tools and technologies comprises a generative AI model designed to summarize and categorize information from diverse inputs, aiding in the identification of technological advancements suitable for integration into the technical environment.

8. The system of claim 1, wherein the intelligent assessment system includes a neural network trained to identify patterns, one or more artificial intelligence models for summarization, and a reinforcement learning with human feedback model to refine assessments and recommendations.

9. The system of claim 1, wherein the management strategy system includes a chatbot including one or more natural language processing and machine learning models to facilitate dynamic interaction with stakeholders regarding the technological debt landscape and available mitigation strategies.

10. A computer-implemented method for evaluating and managing technological debt in a technical environment, the method comprising:
(i) evaluating operational procedures within a tech ecosystem based on the process information;
(ii) assessing the technical foundation of the system based on the technology information;
(iii) incorporating and evaluating governance information to ensure compliance with regulatory standards;
(iv) analyzing the technical environment to understand its impact;
(v) incorporating industry knowledge to align the assessment with current trends and standards;
(vi) evaluating new tools and technologies to identify opportunities for modernization;
(vii) synthesizing the analyzed data to assess technical debt within the ecosystem and identify areas for improvement; and
(viii) generating actionable strategies based on the assessment of technical debt, wherein the strategies include at least a detailed report of technical debts by applications, a report of technical debts by business functions, an interactive chatbot for stakeholder engagement, and a dashboard for visualizing tech debt data and progress in addressing identified debts.

11. The computer-implemented method of claim 10, further comprising:
interfacing with external sources to gather industry knowledge and information on new tools and technologies to receive latest advancements and trends.

12. The computer-implemented method of claim 10, further comprising:
processing, via a generative AI model, at least one of (i) images, (ii) text, (iii) audio, or (iv) video to generate an understanding of operational efficiencies and deficiencies.

13. The computer-implemented method of claim 10, further comprising:
classifying, via one or more trained neural network models, data; and
identifying, via one or more generative AI models, gaps and areas requiring technological updates or enhancements.

14. The computer-implemented method of claim 10, further comprising:
processing, via one or more generative AI models, regulatory requirements to generate reports highlighting compliance gaps and recommended actions.

15. The computer-implemented method of claim 10, further comprising:
extracting, via one or more neural network models, relevant information from a plurality of sources including web publications, domain-specific knowledge bases, and news outlets.

16. The computer-implemented method of claim 10, further comprising:
summarizing and categorizing, via a generative AI model, information from a plurality of inputs to identify technological advancements suitable for integration into the technical environment.

17. The computer-implemented method of claim 10, further comprising:
identifying, via a neural network trained to identify patterns, one or more artificial intelligence models for summarization; and
refining, via a reinforcement learning with human feedback model, assessments and recommendations.

18. The computer-implemented method of claim 10, further comprising:
a chatbot including one or more natural language processing and machine learning models configured to facilitate dynamic interaction with stakeholders regarding the technological debt landscape and available mitigation strategies.

19. A non-transitory computer-readable medium having stored thereon computer-executable instructions that, when executed, cause a computer to:
(i) evaluate operational procedures within a tech ecosystem based on the process information;
(ii) assess the technical foundation of the system based on the technology information;
(iii) incorporate and evaluating governance information to ensure compliance with regulatory standards;
(iv) analyze the technical environment to understand its impact;
(v) incorporate industry knowledge to align the assessment with current trends and standards;
(vi) evaluate new tools and technologies to identify opportunities for modernization;
(vii) synthesize the analyzed data to assess technical debt within the ecosystem and identify areas for improvement; and
(viii) generate actionable strategies based on the assessment of technical debt, wherein the strategies include at least a detailed report of technical debts by applications, a report of technical debts by business functions, an interactive chatbot for stakeholder engagement, and a dashboard for visualizing tech debt data and progress in addressing identified debts.

20. The non-transitory computer-readable medium of claim 19, having stored thereon computer-executable instructions that, when executed, cause a computer to:
process, via a generative AI model, at least one of (i) images, (ii) text, (iii) audio, or (iv) video to generate an understanding of operational efficiencies and deficiencies.
